(19) United States
(12) Patent Application Publication
(10) Pub. No.: US 2026/0061353 A1
(43) Pub. Date: Mar. 5, 2026

(54) FILTER MEDIA COMPRISING ADSORBENT

(71) Applicant: Ahlstrom-Munksjö Oyj, Helsinki (FI)

(72) Inventors: Jesse Shim, Daegu Metropolitan City (KR); Claire Prost, Pont-Evêque (FR); Jessica Lee, Daegu Metropolitan City (KR); Jameson Ha, Daegu Metropolitan City (KR)

(21) Appl. No.: 19/104,608

(22) PCT Filed: Aug. 21, 2023
(86) PCT No.: PCT/IB2023/058318

§ 371 Date: Feb. 18, 2025

Related U.S. Application Data
(60) Provisional application No. 63/399,323, filed on Aug. 19, 2022.

(51) Int. Cl. B01D 39/16; B01J 20/20; B01J 20/28

(52) U.S. Cl. CPC B01D 39/1623; B01J 20/20; B01J 20/28016; B01J 20/2805; B01D 2239/0407; B01D 2239/1233

(57) ABSTRACT

A filter medium including a fibrous container including an open phase, and a second phase on the open phase; and an adsorbent within the fibrous container, wherein each of the open phase and the second phase comprise thicker fibers and thinner fibers, and wherein an average diameter of fiber in the open phase is greater than an average diameter of fibers in the second phase.

### CROSS-REFERENCE TO RELATED APPLICATION

The present application is an international filing which claims priority to U.S. Provisional Application No. 63/399,323, filed Aug. 19, 2022, which is incorporated herein in its entirety.

### FIELD OF THE DISCLOSURE

The present disclosure relates to filter media and uses thereof. The present disclosure also concerns methods of producing the filter media and to the uses of the filter media for removing gases from, e.g., purification of air.

### BACKGROUND OF THE DISCLOSURE

Adsorbents such as activated carbon particles may be incorporated in filter media for a variety of purposes including, but not limited to, a gas adsorption filter, a cabin air filter for a vehicle, an air intake filter for a vehicle, or a heating, ventilation, and air conditioning filter. For example, adsorbents may be used in filter media to remove gases, e.g., harmful gases, in the air. Filter media which contain absorbents remove contaminants from fluids via surface adsorption, where the contaminants are attracted to the surface of the adsorbent and held therein via physical attraction and/or a chemical bond.

To avoid adsorbents such as activated carbon particles “escaping” from the filter media, adhesive may be used to adhere the carbon layer to a fibrous substrate of the filter media. Accordingly, a layer of a filter medium including an adsorbent may additionally include an adhesive. However, high amounts of adhesive such as is used in the prior art can decrease porosity and reduce the overall effectiveness of the media.

For example, a slurry of adsorbent and a liquid adhesive may be applied to a fibrous substrate. The slurry may form a distinct layer on the fibrous substrate and may not be embedded within the fibrous substrate. The distinct layer may separate, or delaminate, from the fibrous substrate. For example, different adhesives will perform differently under different environmental conditions, e.g., temperature, pressure, etc. Additionally, adhesives may lower the performance of the adsorbent, for example, by clogging pores of the adsorbent.

An interest exists for improved filter media, and related methods of fabrication and use.

Opportunities for improvement are addressed and/or overcome by the filter media, assemblies and methods of the present disclosure.

### BRIEF SUMMARY OF THE DISCLOSURE

The present disclosure provides advantageous filter media, and methods for fabricating and utilizing the filter media.

More particularly, the present disclosure provides advantageous filter media including a fibrous container including an open phase, and a second phase on the open phase; and an adsorbent within the fibrous container, wherein each of the open phase and the second phase include a particular combination of thicker fibers and thinner fibers, and wherein an average diameter of fiber in the open phase is greater than an average diameter of fibers in the second phase. In one or more embodiments, the thicker fibers have a thickness from 15 to 20 denier and the thinner fibers have a thickness of 5 to 10 denier. In the present disclosure, the particular proportions of thicker and thinner fibers in the open phase and the second phase as discussed in greater detail below have been found to affect the absorbent loading and overall performance of the filter media.

The above described and other features are exemplified by the following figures and detailed description.

Any combination or permutation of embodiments is envisioned. Additional advantageous features, functions and applications of the disclosed filter media, assemblies and methods of the present disclosure will be apparent from the description which follows, particularly when read in conjunction with the appended figures.

### BRIEF DESCRIPTION OF THE DRAWINGS

The following figures are exemplary embodiments.

Features and aspects of embodiments are described below with reference to the accompanying drawings.

Exemplary embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed filter media, assemblies and methods, reference is made to the appended figures, wherein:

FIG. 1 is a scanning electron microscope (SEM) image of the filter medium of the Comparative Example;

FIG. 2 is an enlarged SEM image of the filter medium of the Comparative Example;

FIG. 3 is an SEM image of the filter medium of Example 2;

FIG. 4 is an enlarged SEM image of the filter medium of Example 2;

FIG. 5 is an SEM image of fibers included in an open phase of a fibrous container of the filter medium of Example 2;

FIG. 6 is an enlarged SEM image of the fibers included in the open phase of the fibrous container of the filter medium of Example 2;

FIG. 7 is an SEM image of fibers included in a second phase of the fibrous container of the filter medium of Example 2;

FIG. 8 is an enlarged SEM image of the fibers included in the second phase of the fibrous container of the filter medium of Example 2;

FIG. 9 is a graph of n-butane (n-B) Breakthrough (percent (%)) versus Time (minutes (min)) showing n-B adsorption of the filter medium of Example 1 and the Comparative Example;

FIG. 10 is a graph of Toluene Breakthrough (%) versus Time (min) showing Toluene adsorption of the filter medium of Example 1 and the Comparative Example;

FIG. 11 is a graph of SO₂ Breakthrough (%) versus Time (min) showing SO₂ adsorption of the filter medium of Example 1 and the Comparative Example;

FIG. 12 is a graph of NO₂ Breakthrough (%) versus Time (min) showing NO₂ adsorption of the filter medium of Example 1 and the Comparative Example;

FIG. 13 is a graph of n-B Breakthrough (%) versus Time (min) showing n-B adsorption of the filter medium of Example 2;

FIG. 14 is a graph of Toluene Breakthrough (%) versus Time (min) showing Toluene adsorption of the filter medium of Example 2;

FIG. 15 is a graph of SO₂ Breakthrough (%) versus Time (min) showing SO₂ adsorption of the filter medium of Example 2;

FIG. 16 is a graph of NO₂ Breakthrough (%) versus Time (min) showing NO₂ adsorption of the filter medium of Example 2;

FIG. 17 is a graph of nitrogen oxides (NOx) Breakthrough (%) versus Time (min) showing NOx adsorption of the filter medium of Example 2;

FIG. 18 is a graph of NH₃ Breakthrough (%) versus Time (min) showing NH₃ adsorption of the filter medium of Example 2;

FIG. 19 is a graph of SO₂ Breakthrough (%) versus Time (min) showing SO₂ adsorption of the filter medium of Example 3;

FIG. 20 is a graph of NOx and NO₂ Breakthrough (%) versus Time (min) showing NOx and NO₂ adsorption of the filter medium of Example 3;

FIG. 21 is a graph of NH₃ Breakthrough (%) versus Time (min) showing NH₃ adsorption of the filter medium of Example 3; and

FIG. 22 is a graph of NH₃ Breakthrough (%) versus Time (min) showing a comparison of NH₃ adsorption of the filter media of Example 2 and Example 3.

### DETAILED DESCRIPTION OF THE DISCLOSURE

The exemplary embodiments disclosed herein are illustrative of advantageous filter media, and methods/techniques thereof. It should be understood, however, that the disclosed embodiments are merely exemplary of the present disclosure, which may be embodied in various forms. Therefore, details disclosed herein with reference to exemplary filter media and associated processes/techniques of assembly and use are not to be interpreted as limiting, but merely as the basis for teaching one skilled in the art how to make and use the advantageous filter media and/or alternative filter media of the present disclosure.

The term “nonwoven” refers to a collection of fibers in a web or mat which may be randomly interlocked, entangled and/or bound to one another so as to form a self-supporting structural element.

“Synthetic fiber” refers to fibers made from fiber-forming substances including polymers synthesized from chemical compounds and modified or transformed natural polymer materials. Such fibers may be produced by, for example, melt-spinning, solution-spinning, or solvent spinning.

Exemplary synthetic fibers suitable for the present disclosure are polyesters (e.g., polyalkylene terephthalates such as polyethylene terephthalate (PET), polybutylene terephthalate (PBT) and the like), polyalkylenes (e.g., polyethylenes, polypropylenes and the like), polyacrylonitriles (PAN), and polyamides (nylons, for example, nylon-6, nylon 6,6, nylon-6,12, and the like). In an embodiment, the synthetic fibers may be bicomponent sheath-core fibers such as PE-PP fibers, PP-PET fibers, and low-melting PET-PET fibers, or a combination thereof. In an embodiment, the sheath may include a PET copolymer (co-PET), e.g., the bicomponent sheath-core fiber may be a co-PET-PET fiber. Bicomponent fibers may have a lower melting point sheath and a higher melting point core.

The term “adsorb” may be used for designating the sorption of substances, such as gases, to an adsorbent, and thus a filter containing an adsorbent may be referred to as an “adsorption” filter.

The phrase “spunbond fibers” refers to fibers formed by a process in which fibers are formed by extruding molten thermoplastic polymer material from a plurality of fine capillaries of a spinneret, with the diameter of the extruded fibers then being rapidly reduced by drawing. Spunbond fibers may be laid randomly on a collecting surface such as a foraminous screen or belt. The phrase “spunbond nonwoven” refers to a nonwoven including spunbond fibers that may be bonded by methods such as hot-roll calendering, through air bonding (which may be applicable to multiple component spunbond nonwovens), or passing the nonwoven through a saturated steam chamber at an elevated pressure.

The phrase “meltblown fibers” refers to fibers formed by a process in which hot compressed air is applied directly at the outlet of a die. Thus, the fibers obtained have a smaller diameter than spunbond fibers. The process for forming meltblown fibers may not include a separate bonding step, the meltblown fibers being sufficiently hot at the outlet of the die to bond when deposited on a forming mat.

Disclosed herein are advantageous filter media, and related methods of fabrication and use thereof. The present disclosure provides improved filter media, and improved methods for utilizing and fabricating filter media.

The present disclosure provides advantageous filter media including a fibrous container including an open phase and a second phase on, e.g., adjacent or directly on, the open phase; and an adsorbent within the fibrous container, wherein each of the open phase and the second phase include thicker fibers and thinner fibers, and wherein an average pore size of the open phase is greater than an average pore size of the second phase.

The present inventors surprisingly discovered that by using a double layer fibrous “container” including the open and second phases, a larger amount of adsorbent may be included within the fibrous container. It is believed that the open phase structure allows adsorbent to be loaded into the open phase and penetrate into the thickness of the material instead of being concentrated on the container surface. This allows a larger amount of adsorbent to be loaded, e.g., amounts greater than 500 g/m². Also, the tighter structure based on the proportion of the thicker and thinner fibers in the second phase prevents release of the adsorbent from the pores. Little or no adhesive may be within, e.g., provided onto, the fibrous container to hold the adsorbent in the fibrous container, e.g., in the open phase, which increases the effective utilization of the surface area of the filter media and produces better filtration performance. In an embodiment, an amount of adhesive within, e.g., provided onto, the fibrous container is less than 10 weight percent (wt %), based on a total weight of the adsorbent. In an embodiment, 0 wt % of adhesive is used within, e.g., provided onto, the fibrous container, based on a total weight of the adsorbent. The use of little or no adhesive provide improved performance.

The use of little or no adhesive may allow for better performance. Equivalent or better performance may be achieved with the disclosed filter media as compared to filter media having more adhesive, which may affect gas adsorption performance. Gas adsorption performance of adsorbents may be reduced due to reduction of surface area, e.g., pore plugging or coverage, of adsorbents by liquid adhesive. Moreover, liquid adhesive may plug a fibrous substrate. For example, FIG. 1 shows a filter medium with liquid adhesive (shown by arrows) covering activated carbon particles.

The use of little or no adhesive may also allow for differing adsorbent to be used depending on the desired characteristics and end use of the filter medium. The choice of adsorbent may be tailored to the desired characteristics and end use of the filter medium as interaction between the adhesive and the adsorbent, e.g., pore plugging or coverage of the adsorbent by the adhesive, may be minimized or nonexistent.

The pore size gradient between the open phase and the second phase results in more effective adsorbent loading, utilization, distribution, or a combination thereof through an entire thickness of the fibrous container resulting in improved performance due to more effective utilization of the surface area for filtration. The average pore size in each of the open phase and second phase may be a result of amounts of different fiber sizes, e.g., denier, diameter, or a combination thereof, in each of the phases. The open phase may include less pores than the second layer, but the pores of the open phase may be larger than the pores of the second phase, e.g., the open phase may be a larger average pore diameter than the second phase.

The retention of the adsorbent is because of the asymmetrical/gradient fiber structure of the media. For example, the pore size gradient provided by the tighter second phase on the open phase may help retain a large amount of the adsorbent within the fibrous container and prevent a large amount, e.g., a majority, of the adsorbent from collecting at a surface of the fibrous container opposite a surface to which the adsorbent is added. Presence of a large amount of adsorbent at a surface of the fibrous container may, for example, contribute to delamination of such a surface of the fibrous container from a cover layer laminated to the surface of the fibrous container or an asymmetric structure of a filter medium, which may adversely affect a pleating process to form the filter medium.

In an embodiment, an average pore size of the open phase is greater than an average pore size of the second phase. In an embodiment, a proportion of the thicker fibers in the open phase is less than or equal to a proportion of the thinner fibers in the open phase. In an embodiment, a proportion of the thicker fibers in the second phase is less than a proportion of the thinner fibers in the second phase. In an embodiment, a proportion of the thicker fibers in the open phase is greater than a proportion of the thicker fibers in the second phase. In an embodiment, a proportion of the thinner fibers in the open phase is less than a proportion of the thinner fibers in the second phase. As used herein, a proportion may refer to a weight percentage of the stated fiber type relative to a total fiber weight in the stated phase.

The fibrous container may have a weight of 30 to 120 grams per square meter (g/m²), for example, 60 to 90 g/m². The fibrous container may include 50 to 70 wt % of the open phase and 30 to 50 wt % of second phase, based on a total weight of the fibrous container.

In an embodiment, the thicker fibers are present in the open phase in an amount of 30 to 50 wt %, based on a total fiber weight of the open phase. In an embodiment, the thicker fibers include 15 to 20 denier fibers. In an embodiment, the thinner fibers are present in the open phase in an amount of greater than or equal to 50 wt %, for example, 50 to 70 wt %, based on a fiber weight of the open phase. In an embodiment, the thinner fibers include 5 to less than 10 denier fibers or 7 to less than 10 denier fibers. In an embodiment, the thicker fibers are present in the second phase in an amount of 10 to 20 wt %, based on a fiber weight of the second phase. In an embodiment, the thinner fibers are present in the second phase in an amount of 80 to 90 wt %, based on a fiber weight of the second phase. In an embodiment, the thinner fibers are present in the second phase in an amount of greater than or equal to 50, based on a fiber weight of the second phase.

The open phase may include 30 to 50 wt % of 15 to 20 denier synthetic fibers and 50 to 70 wt % of 5 to less than 10 denier synthetic fibers, for example, 7 to less than 10 denier synthetic fibers, based on a total weight of the open phase. The second phase may include 10 to 30 wt % of 10 to 20 denier synthetic fibers and 70 to 90 wt % of 5 to less than 10 denier synthetic fibers, for example, 7 to less than 10 denier synthetic fibers, based on a total weight of the second phase. Denier may be measured by ASTM D-1577.

The fibers included the fibrous container may include low-melting fibers, for example, in an amount of greater than or equal to 50 wt %, or 50 to 70 wt %, based on a total fiber weight of the fibrous container. As used herein, the phrase a “low-melting fiber” may refer to a bicomponent sheath-core fiber that has a sheath having a low melting point, and a core having a higher melting point.

In an embodiment, the thicker fibers include polyethylene terephthalate fibers. In an embodiment, the thinner fibers include polyethylene terephthalate fibers.

In an embodiment, fibers included in the fibrous container may include regular PET fibers, for example, in an amount of less than or equal to 50 wt %, or 30 to 50 wt %, based on a total weight of PET fibers (e.g., based on a total weight of regular PET fibers and low-melting PET fibers). As used herein, a “regular” PET fiber may have a single component having a melting point of about 265° C.

The fibrous container including an open phase and a second phase may be a thermal bonded nonwoven, e.g., the open phase and the second phase may be thermally bonded to one another. The filter medium may include at least one additional spunbond nonwoven laminated on the at least one surface of the fibrous container. In an embodiment, the filter medium may include additional spunbond nonwovens laminated on opposing surfaces of the fibrous container to prevent release of adsorbent from a surface of the fibrous container.

The fibrous container including the open phase and the second phase may be made of by two card machines. The open phase and the second phase formed by the two card machines may be fed into a belt hot air dryer and combined into the fibrous container. The second phase may be placed on a belt surface to create smaller pores than the open phase. Any suitable type of air through dryer may be used for bonding the two layers, for example, a belt type air through dryer may be used to make the fibrous container with a pore size gradient.

To insert adsorbent into the fibrous container, adsorbent may be scattered on the open phase at one step. In an embodiment, the adsorbent may be scattered in multiple steps. However, even if the adsorbent is scattered in multiple steps, the container structure should be advantageously chosen such that the adsorbent scattered first does not get retained only on the open phase, preventing the next adsorbent from entering inside of the fibrous container.

The adsorbent may be present in an amount of greater than 50 g/m², for example, greater than 100 g/m², greater than 200 g/m², greater than 300 g/m², greater than 500 g/m², or greater than 600 g/m². In an embodiment, the adsorbent is present in an amount of less than 1,000 g/m², for example, less than 900 g/m², or less than 800 g/m². In an embodiment, the adsorbent is present in an amount of 50 g/m² to 1,000 g/m², for example, 500 g/m² to 900 g/m², or 600 g/m² to 800 g/m².

Exemplary adsorbents for use in the disclosed filter medium include particulate such as activated carbon particles, silica, zeolite, molecular sieve, clay, alumina, sodium bicarbonate, ion exchange resin, catalyst including an enzymatic agent, metal oxide, air freshening, or perfuming particulates, such as titanium dioxide, or a combination thereof. Fungicidal particulate may be incorporated into a filter medium, such as for an automobile climate control system to remove mildew and mildew odors from circulated air. Biocidal particulate, virucidal particulate, or a combination thereof may be incorporated into a filter medium.

In an embodiment, the adsorbent includes activated carbon particles, silica, zeolite, molecular sieve, clay, alumina, sodium bicarbonate, ion exchange resin, catalyst, or a combination thereof. In an embodiment, the adsorbent includes activated carbon particles. In an embodiment, the adsorbent includes activated carbon particles and ion exchange resin. The ion exchange resin may aid, for example, with NH₃ adsorption.

In an embodiment, the activated carbon particles includes activated carbon powder, for example, a powder formed by particles having an average particle size in the range of 0.05 to 1.5 millimeters (mm), for example, 0.1 to 1.5 mm, 0.15 to 1.0 mm, or 0.3 to 1.0 mm. The activated carbon particles may be an impregnated, for example, with an acid or base to adsorb a basic gas or acidic gas, respectively. For example, the activated carbon particles may be an impregnated with H₃PO₄ (phosphoric acid) (e.g., in an amount of 20 wt %, based on a total weight of the impregnated activated carbon particles) or KI (potassium iodine) (e.g., in an amount of 3 wt %, based on a total weight of the impregnated activated carbon particles). In an embodiment, the adsorbent includes differing impregnated activated carbon particles, for example, activated carbon particles impregnated with H₃PO₄ and activated carbon particles impregnated with KI. In an embodiment, the adsorbent includes impregnated activated carbon particles and ion exchange resin. In an embodiment, the activated carbon may have a size of 20 to 80 mesh, for example, 0.17 to 0.85 mm in diameter.

Inclusion of different adsorbents, for example, activated carbon particles, impregnated activated carbon particles, ion exchange resins, or a combination thereof may allow a single filter medium to treat, e.g., filter, multiple, e.g., two, three, four, or more than four, different compounds, e.g., volatile organic compounds (VOCs), and at fine particulate levels. For example, a filter medium including different adsorbents may allow for at least two of a particulate efficiency of 99.5% on 0.3 micrometer (μm) NaCl at 20 centimeters per second (cm/s) (DIN71460-1), a target n-butane initial breakthrough of 1% at 10 cm/s (DIN71460-2), a target SO₂ initial breakthrough of 1.5% at 10 cm/s (DIN71460-2), a target NOx initial breakthrough of 0% at 10 cm/s (DIN71460-2), or a target NH₃ initial breakthrough of 0% at 10 cm/s (DIN71460-2).

In an embodiment, the adsorbent may include zeolite, alumina, ion exchange resin, or a combination thereof. The zeolite, alumina, ion exchange resin, or combination thereof may have a density of 0.5 to 0.7 grams per cubic meter (g/cm³) and a size of 20 to 80 mesh. In an embodiment, such adsorbent may be used alone or in a mixture with activated carbon particles. In an embodiment, a mixture of modified, e.g., impregnated, activated carbon and ion exchange resin may provide improved gas adsorption properties.

A process of forming the disclosed filter medium may include forming the thermally bonded fibrous “container” by combining/carding the open phase and the second phase together. A first card machine may form the open phase and a second card machine may form the second phase.

Forming the fibrous container may include intermingling the thicker fibers and the thinner fibers in the open phase and the second phase. The open phase and the second phase may be needled, e.g., needle-punched, with one another. In an embodiment, the open phase and the second phase may be thermal bonded with an air through dryer.

In an embodiment, the disclosed filter medium may be formed by a process including forming the fibrous container; providing the adsorbent onto the fibrous container; and laminating the fibrous container to form the filter medium. In an embodiment, the process further includes providing adhesive onto the fibrous container after adding the adsorbent onto the fibrous container.

In an embodiment, the adhesive includes a powder. In an embodiment, the adhesive includes a web. In an embodiment, the adhesive is not present in the second phase. In an embodiment, less than 1 wt % of adhesive is present in the second phase, based on a total weight of the second phase. An amount of adhesive may be determined, for example, by pyrolyze Gas Chromatography/Mass Spectrometry (GC-MS). In an embodiment, forming the fibrous container includes intermingling the thicker fibers and the thinner fibers in the open phase and the second phase.

The open phase may be oriented on top of the second phase. As the adsorbent is provided, e.g., scattered, onto the fibrous container, gravity may assist the adsorbent to fall into the open phase of the fibrous container. The pore size gradient may assist with retaining larger adsorbent particles at a top surface of the fibrous contain and allow smaller adsorbent particles to fall to farther into the fibrous container.

In an embodiment, the filter medium further includes a cover layer. In an embodiment, the cover layer includes spunbond fibers. In an embodiment, the cover layer includes an electrostatically charged layer, e.g., an electrostatically charged meltblown nonwoven. Adhesive present in the filter medium further may be present only at an interface between the fibrous container and the cover layer, e.g., the adhesive may not enter into the fibrous container after application of the adhesive onto the fibrous container.

Opposing surfaces of the fibrous container may be laminated with a spunbond nonwoven as a cover layer. The spunbond nonwoven may prevent adsorbent from releasing from, e.g., exiting, a surface of the fibrous container. Exemplary methods for laminating a spunbond nonwoven to the fibrous container include hot melt spray lamination, hot melt powder lamination, and hot melt web lamination. In an embodiment, a thickness of the fibrous container may not be reduced during lamination. If the thickness of the fibrous container is reduced excessive during lamination, the fibrous container may not function properly to hold adsorbent.

The spunbond nonwoven used for lamination to the fibrous container may be relatively thin and has good air permeability. For example, the spunbond nonwoven may include 10 to 40 g/m² of PP or PET spunbond fibers. In an embodiment, the spunbond nonwoven may include 15 to 30 g/m² PP or PET spunbond fibers. The spunbond nonwoven may have a thickness of 0.10 to 0.40 mm. In an embodiment, instead of a spunbond nonwoven, a calendared thermal bonded nonwoven having a basis weight of 30 to 70 g/m² and thickness of 0.20 to 0.40 mm may be laminated to the fibrous container.

The spunbond nonwoven may include one or more additive components. The additive component may be, for example, a dyeing agent, which may be required to give the filtration agent a favorable appearance; a fiber retention agent; a separation aide (e.g., a silicone additive and associated catalyzer); a fire or flame retardant; a hydrophilic or hydrophobic agent; a wetting agent; an antistatic agent; an antimicrobial agent; or a combination thereof. If present, these additives may be included in amounts of greater than 0 wt %, 0.01 wt %, 0.1 wt %, 1 wt %, 5 wt %, 10 wt % and/or less than about 30 wt %, 25 wt %, 20 wt %, 15 wt %, 10 wt %, 9 wt %, 8 wt %, 7 wt %, 6 wt %, 5 wt %, 4 wt %, 3 wt %, 2 wt %, 1 wt %, or a combination thereof, including for example between 0.1 wt % and 10 wt %, based on a total weight of the cover layer.

The adsorbent may be scattered by a scattering device on the fibrous container laminated with a spunbond nonwoven. The adsorbent may be scattered with several scattering devices. In an embedment, the adsorbent is scattered with one scattering device. If the adsorbent is scattered by multiple scattering devices, the adsorbent scattered first may block pores on the surface of the fibrous container and prevent the adsorbent scattered a subsequent time from entering inside of the fibrous container. Brushes or vibrating device may be used to aid the scattered adsorbent into an inside of the fibrous container.

In an embodiment, after scattering of the adsorbent onto the fibrous container, a, a brushing technique may be used, for example, 2 to 3 times, to assist the adsorbent penetrate the pores of the fibrous container. Smaller adsorbent particles may fall or get pushed farther into the fibrous container, and larger adsorbent particles may remain on or towards a top of the fibrous container.

A hotmelt powder adhesive, a hotmelt web adhesive, or a combination thereof may be provided onto the fibrous container containing adsorbent, for example, to laminate the fibrous container containing adsorbent and a cover layer. A hotmelt powder may be used in an amount of less than or equal to 10 wt %, based on a total adsorbent weight. A hot melt powder may be made of polyurethane (PU), PET, ethylene-vinyl acetate (EVA), polyamide (PA), or a copolymer thereof. A hotmelt powder may have a diameter of 0.1 to 0.4 mm. A hotmelt powder may have a melting point of 70 to 160° C. A hot melt powder adhesive may bond adsorbed located on a surface of the fibrous container. In an embodiment, a hot melt powder may have a basis weight of greater than 0 to 60 30 g/m².

In an embodiment, the fibrous container include adhesive in an amount of greater than 0 and less than 10 wt %, based on a total weight of the adsorbent. In an embodiment, the fibrous container includes less than 1 wt %, for example, 0 wt %, adhesive, based on a total weight of the adsorbent.

A hotmelt web adhesive may have a basis weight of 5 to 30 g/m², for example, 10 g/m². Exemplary hotmelt web adhesives may include polyurethane PU, EVA, polyamide PA, PET, or a copolymer thereof. The hot melt web adhesive may bond an adsorbent layer and a cover layer.

The cover layer laminated with the adsorbent layer may be the same nonwoven used for lamination with the fibrous container. If additional lamination with filtration efficiency layer such as meltblown is desired, another cover layer lighter than the first cover layer may be used.

The final filter medium may be formed by lamination, e.g., the layers may be heated and bound together. For example, a flat-bed laminator may be used. The laminating process may be controlled by adjusting machine speed, for example, 3 to 10 meters per minute (m/min), temperature, for example, 130 to 200° C., and pressure, for example, 0 to 5 megapascals (MPa). The final filter medium may be formed with or without a calendering step. During lamination, e.g., a belt dry lamination process, adsorbent may enter the fibrous container or move farther within the fibrous container.

In an embodiment, one or more additional layers of the filter medium may include an “efficiency layer,” for higher particulate filtration efficiency. The efficiency layer may include, for example, nanofibers, meltblown fibers, an expanded polytetrafluoroethylene (ePTFE) membrane, an electrically charged needle-felt, a nonwoven containing microglassfibers, or a combination thereof. In an embodiment, an efficiency layer may have a basis weight of 15 to 30 g/m² and include PP meltblown fibers. In an embodiment, the efficiency layer includes an electrostatically charged layer, e.g., an electrostatically charged meltblown nonwoven.

The filter medium may have a basis weight of 700 to 1,390 g/m². For example, a filter medium having a basis weight of 700 g/m² may include 500 g/m² of adsorbent, without an efficiency layer, and a filter medium having a basis weight of 1,390 g/m² may include 1,000 g/m² of adsorbent, with an efficiency layer.

The filter medium may have a thickness of greater than or equal to 2.0 mm, for example, greater than or equal to 2.4 mm. The thickness directed may be a stacking direction of the open phase on the second phase. The filter medium may have a thickness of less than or equal to 4.0 mm, for example, less than 2.5 mm, and the fibrous container may have a thickness of less than or equal to 3.5 mm. Thinner filter medium provides lower air permeability of the filter medium and thicker filter medium provides greater air permeability of the filter medium. In an embodiment, the filter medium has a thickness of less than 2.5 mm to aid with pleating. A filter medium having a thickness of greater than 2.5 may be difficult to pleat.

Air permeability of the filter medium may be 5 to 200 cubic feet per minute (cfm) depending on the efficiency layer. For example, an efficiency layer including meltblown fiber may have a low air permeability and may decrease the overall air permeability of the filter medium.

To prevent delamination of the fibrous container from an adjacent cover layer or additional layer, an adhesive web may be added between the fibrous container and the adjacent cover layer or additional layer. The adhesive web may have a basis weight of 5 to 30 g/m², for example, 10 g/m². Exemplary adhesive webs may include PU, EVA, PA, PET, or a copolymer thereof.

The filter medium may be configured for use as a fuel cell air intake filter. The filter medium may filter particles to limit clogging of channels and a proton exchange membrane in the fuel cell. The filter medium may remove volatile organic compounds (VOCs), SO₂, NOX, NH₃, or a combination thereof and extend a lifetime of a catalyst (e.g., platinum) of the fuel cell and improve service intervals of the fuel cell. For example, the disclosed filter medium may be suitable for applications including an intake air filter medium for fuel cells for electric vehicles (EVs).

The filter medium may be configured to filter automotive cabin air, for example, the disclosed filter medium may be suitable for applications including cabin filter media for EVs. The filter medium may be configured to filter particulates (such as dust, pollen, soot, bacteria and particulate matter 2.5 (PM2.5)), gases (such as ozone, benzene, sulfur oxides (SOx), and NOx), odors, or a combination thereof from cabin air.

The air filter medium may be configured as an automotive engine air intake filter, which may be configured to filter particulates (such as dust, pollen, soot, bacteria and PM2.5) from air entering an engine of a vehicle. The air filter medium may be configured for a gas turbine air intake filter, an air-oil separation filter (e.g., in compressed air applications), an air pollution control and dust collection filter element (such as may be used to reduce or eliminate the emission of particles into the atmosphere from industrial sources), or a heating, ventilation and air conditioning (HVAC) filter element, among others. The air filter medium may be configured as an HVAC molecular filter. The air filter medium may be configured as a room air purifier.

Accordingly, a gas adsorption filter, a cabin air filter for a vehicle, an air intake filter for a vehicle, or a heating, ventilation, and air conditioning filter, may include the disclosed filter medium. Depending on the end-use of the product, the filtration characteristics and properties of the disclosed filter medium may differ.

This disclosure is further illustrated by the following examples, which are non-limiting.

### EXAMPLES

### Comparative Example

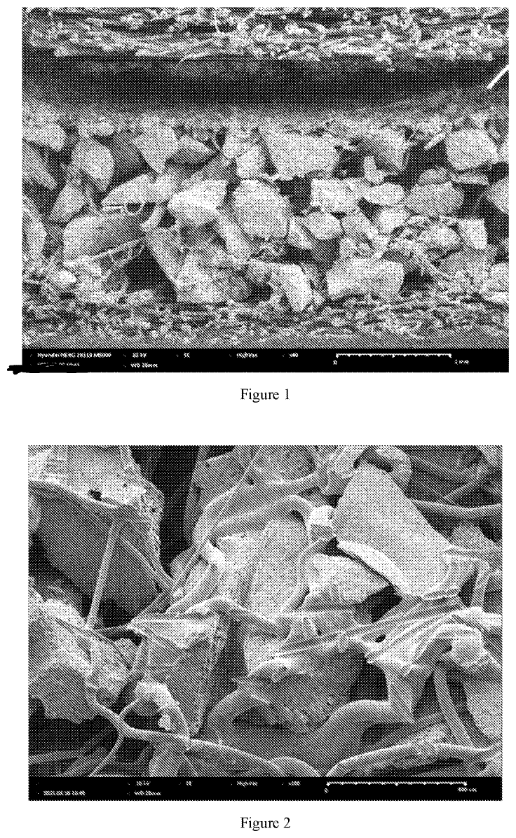

The Comparative Example included activated carbon and hotmelt spray adhesive used to bond activated carbon particles and to laminate nonwoven layers. FIG. 1 is an SEM image of the filter medium of the Comparative Example and FIG. 2 is an enlarged SEM image of the filter medium of the Comparative Example.

### Example 1

A spunbond nonwoven including 25 g/m² of PET fibers was laminated to a fibrous container having a basis weight of 90 g/m² with 5 g/m² hotmelt powder adhesive. The open phase of the fibrous container included 50 wt % of 15 denier bicomponent PET fibers and 50 wt % of 6 denier bicomponent PET fibers. The second phase of the fibrous container included 30 wt % of 15 denier bicomponent PET fibers and 70 wt % of 6 denier bicomponent PET fibers. The weight of the open phase and second phase was 45 g/m² each.

The fibrous container included 700 g/m² of activated carbon particles impregnated with 3 wt % KI (potassium iodine). The impregnated activated carbon has a size of 30 to 80 mesh. After addition of the activated carbon particles, another 25 g/m² PET fiber spunbond nonwoven was laminated to an opposite surface of the fibrous container using a flat-bed laminator at a machine speed of 4 m/min, laminating machine temperature of 160 to 190° C., and laminating pressure of 4 MPa. For the lamination of the cover layer, 60 g/m² of hotmelt powder adhesive made of PET copolymer (co-PET) and 10 g/m² of hotmelt web adhesive made of co-PET were used.

An E10 class meltblown nonwoven having a basis weight of 30 g/m² and including PP meltblown fibers was used as an efficiency layer. The efficiency layer has a 86.2% efficiency at 0.3 micrometers NaCl test aerosol at 32LPM test air flow rate. A meltblown nonwoven was laminated with a hotmelt web adhesive made of co-PET.

### Example 2

A spunbond nonwoven including 25 grams per square meter (g/m²) of polyethylene terephthalate (PET) fibers was laminated to a fibrous container having a basis weight of 90 g/m² with 5 g/m² hotmelt powder adhesive. The open phase of the fibrous container included 50 weight percent (wt %) of 15 denier bicomponent PET fibers and 50 wt % of 6 denier bi-component PET fibers. The second phase of the fibrous container included 30 wt % of 15 denier bi-component PET fibers and 70 wt % of 6 denier bicomponent PET fibers. The weight of the open phase and second phase was 45 g/m² each.

The fibrous container included 500 g/m² of activated carbon particles impregnated with 3 wt % KI and 200 g/m² of activated carbon particles impregnated with 20 wt % H₃PO₄ (phosphoric acid). After addition of the activated carbon particles, another 25 g/m² PET fiber spunbond nonwoven was laminated to an opposite surface of the fibrous container using a flat-bed laminator at a machine speed of 4 meters per minute (m/min), laminating machine temperature of 160 to 190° C., and laminating pressure of 4 megapascals (MPa). For the lamination of the cover layer, 60 g/m² of hotmelt powder adhesive made of a co-PET and 10 g/m² of hotmelt web adhesive made of co-PET were used.

An H13 class meltblown nonwoven having a basis weight of 30 g/m² and including PP meltblown fibers was used as an efficiency layer. The efficiency layer has a 99.97% efficiency at 0.3 micrometers NaCl test aerosol at 32LPM test air flow rate. A meltblown nonwoven was laminated with a hotmelt web adhesive made of co-PET.

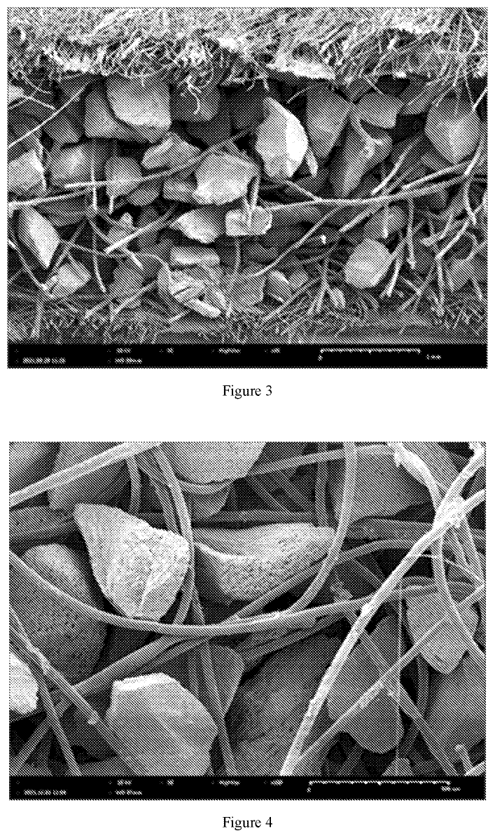

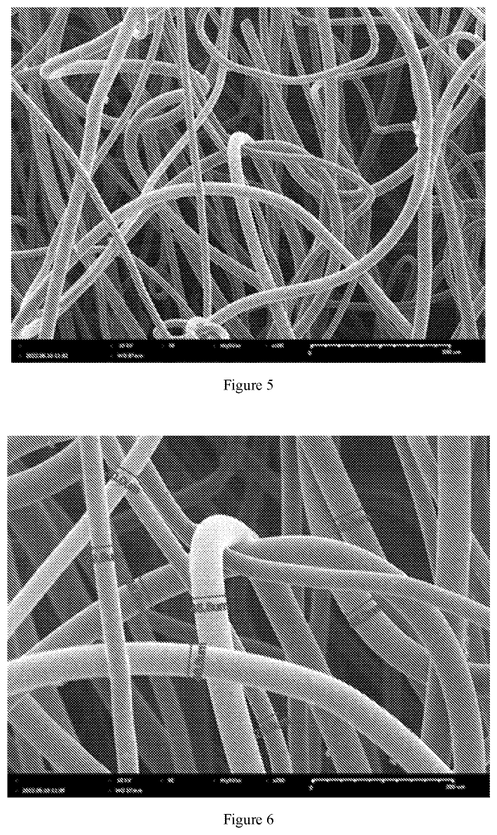

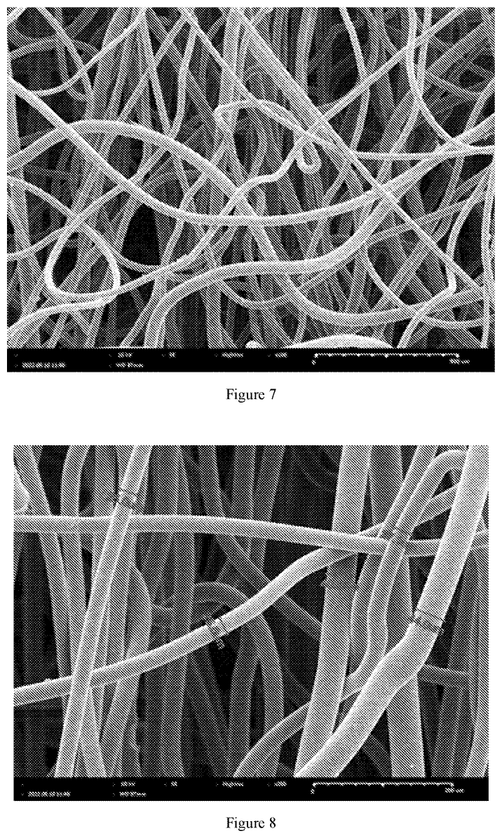

FIG. 3 is a scanning electron microscope (SEM) image of the filter medium of Example 2; FIG. 4 is an enlarged SEM image of the filter medium of Example 2; FIG. 5 is an SEM image of fibers included in an open phase of a fibrous container of the filter medium of Example 2; FIG. 6 is an enlarged SEM image of the fibers included in the open phase of the fibrous container of the filter medium of Example 2; FIG. 7 is an SEM image of fibers included in a second phase of the fibrous container of the filter medium of Example 2; and FIG. 8 is an enlarged SEM image of the fibers included in the second phase of the fibrous container of the filter medium of Example 2.

### Example 3

Example 3 included 560 g/m² of activated carbon particles impregnated with 3 wt % KI and 140 g/m² of a dry-type ion exchange ion exchange resin having a polystyrene and divinyl benzene matrix and sulfonic acid functional group.

Physical properties of Examples 1 to 3 and the Comparative Example are provided in Table 1.

TABLE 1

| Physical | | Metric | Test | Example | Example | Example | Comparative |
|---|---|---|---|---|---|---|---|
| properties | Conditions | Unit | Method | 1 | 2 | 3 | Example |
| Basis weight | / | g/m² | ISO536 | 920 | 920 | 985 | 925 |
| Thickness | 20 kilopascals | millimeters | ISO9073-2 | 2.40 | 2.25 | 2.35 | 2.76 |
| | (kPa)/35 Ø | (mm) | | | | | |
| Air | 125 pascals | cubic feet | TAPPI 251 | 35 | 33 | 29.4 | 63 |
| permeability | (Pa)/38 square | per minute | | | | | |
| | centimeters | (cfm) | | | | | |
| | (cm²) | | | | | | |
| Stiffness | Dry | mgs | TAPPI 543 | 15,000 | 11,000 | 14,000 | — |
| Loading | | g/m² | | 700 | 700 | 700 | 1,000 |
| amount of | | | | | | | |
| activated | | | | | | | |
| carbon | | | | | | | |

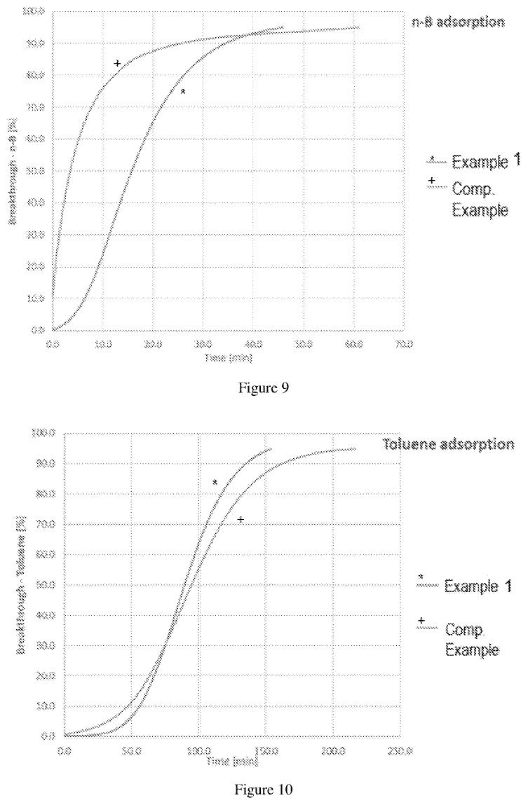

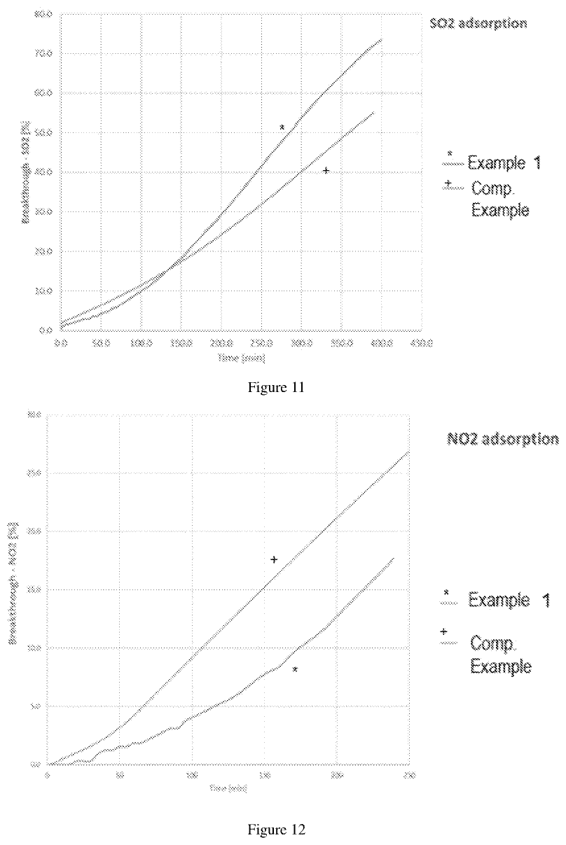

FIG. 9 is a graph of n-butane (n-B) Breakthrough (percent (%)) versus Time (minutes (min)) showing n-B adsorption of the filter medium of Example 1 and the Comparative Example; FIG. 10 is a graph of Toluene Breakthrough (%) versus Time (min) showing Toluene adsorption of the filter medium of Example 1 and the Comparative Example; FIG. 11 is a graph of SO₂ Breakthrough (%) versus Time (min) showing SO₂ adsorption of the filter medium of Example 1 and the Comparative Example; and FIG. 12 is a graph of NO₂ Breakthrough (%) versus Time (min) showing NO₂ adsorption of the filter medium of Example 1 and the Comparative Example.

Example 1 exhibited better performance in adsorption of n-butane and NO₂, and similar in adsorption of Toluene and SO₂, as compared to the Comparative Example, which included a greater loading of activated carbon particles.

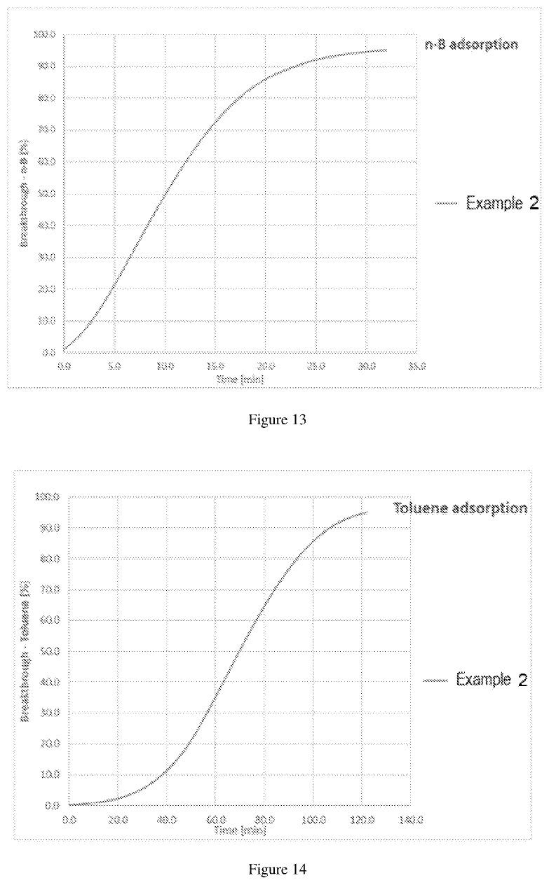

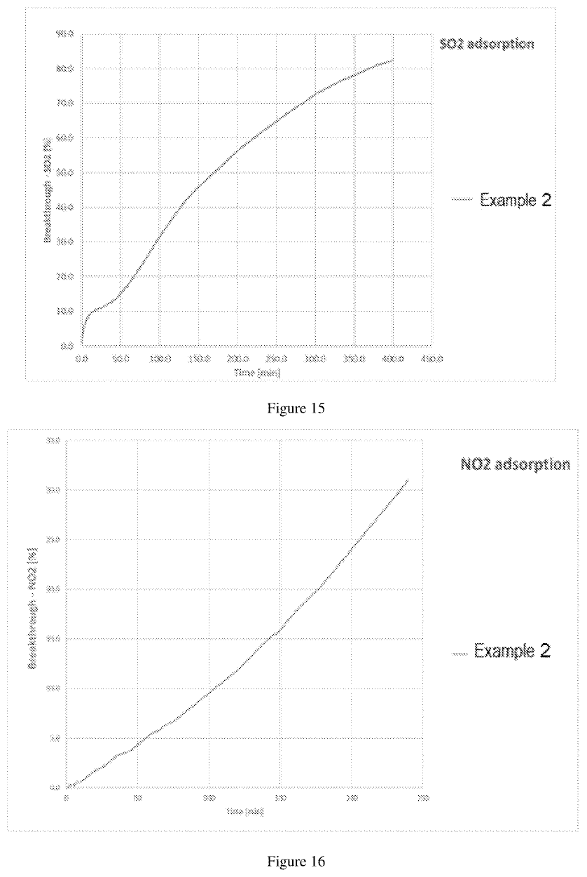

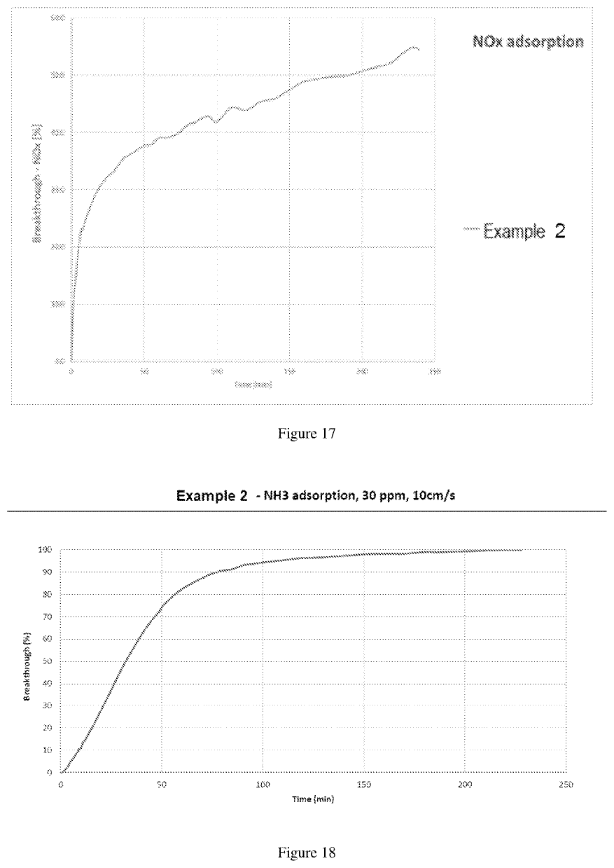

FIG. 13 is a graph of n-B Breakthrough (%) versus Time (min) showing n-B adsorption of the filter medium of Example 2; FIG. 14 is a graph of Toluene Breakthrough (%) versus Time (min) showing Toluene adsorption of the filter medium of Example 2; FIG. 15 is a graph of SO₂ Breakthrough (%) versus Time (min) showing SO₂ adsorption of the filter medium of Example 2; FIG. 16 is a graph of NO₂ Breakthrough (%) versus Time (min) showing NO₂ adsorption of the filter medium of Example 2; FIG. 17 is a graph of nitrogen oxides (NOx) Breakthrough (%) versus Time (min) showing NOx adsorption of the filter medium of Example 2; and FIG. 18 is a graph of NH₃ Breakthrough (%) versus Time (min) showing NH₃ adsorption of the filter medium of Example 2.

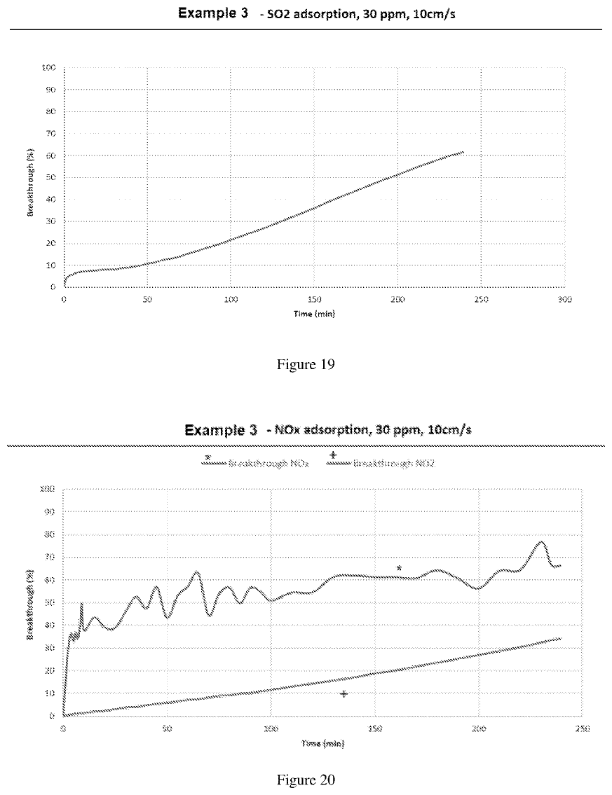

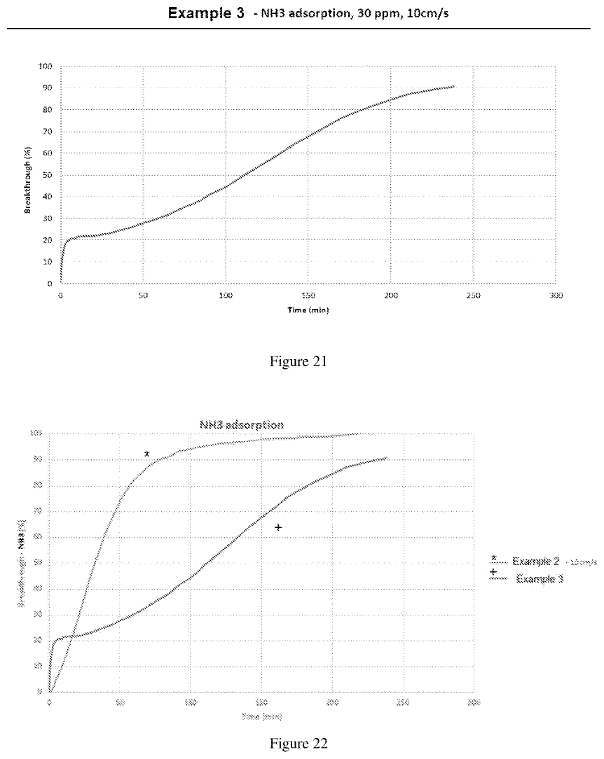

FIG. 19 is a graph of SO₂ Breakthrough (%) versus Time (min) showing SO₂ adsorption of the filter medium of Example 3; FIG. 20 is a graph of NOx and NO₂ Breakthrough (%) versus Time (min) showing NOx and NO₂ adsorption of the filter medium of Example 3; and FIG. 21 is a graph of NH₃ Breakthrough (%) versus Time (min) showing NH₃ adsorption of the filter medium of Example 3.

FIG. 22 is a graph of NH₃ Breakthrough (%) versus Time (min) showing a comparison of NH₃ adsorption of the filter media of Example 2 and Example 3. FIG. 22 demonstrates the technical benefit of using an ion exchange resin for NH₃ adsorption.

This disclosure further encompasses the following aspects.

Aspect 1. A filter medium comprising: a fibrous container comprising
an open phase, and a second phase on the open phase; and an adsorbent within the fibrous container, wherein each of the open phase and the second phase comprise thicker fibers and thinner fibers, and wherein an average diameter of fiber in the open phase is greater than an average diameter of fibers in the second phase.

Aspect 2. The filter medium of aspect 1, wherein an average pore size of the open phase is greater than an average pore size of the second phase.

Aspect 3. The filter medium of aspect 1 or 2, wherein a proportion of the thicker fibers in the open phase is less than or equal to a proportion of the thinner fibers in the open phase.

Aspect 4. The filter medium any one or more of the preceding aspects, wherein a proportion of the thicker fibers in the second phase is less than a proportion of the thinner fibers in the second phase.

Aspect 5. The filter medium of any one or more of the preceding aspects, wherein a proportion of the thicker fibers in the open phase is greater than a proportion of the thicker fibers in the second phase.

Aspect 6. The filter medium of any one or more of the preceding aspects, wherein a proportion of the thinner fibers in the open phase is less than a proportion of the thinner fibers in the second phase.

Aspect 7. The filter medium of any one or more of the preceding aspects, wherein the thicker fibers are present in the open phase in an amount of 30 to 50 weight percent, based on a total fiber weight of the open phase.

Aspect 8. The filter medium of any one or more of the preceding aspects, wherein the thicker fibers comprise 15 to 20 denier fibers.

Aspect 9. The filter medium of any one or more of the preceding aspects, wherein the thinner fibers are present in the open phase in an amount of 50 to 70 weight percent, based on a fiber weight of the open phase.

Aspect 10. The filter medium of any one or more of the preceding aspects, wherein the thinner fibers comprise 5 to less than 10 denier fibers or 7 to less than 10 denier fibers.

Aspect 11. The filter medium of any one or more of the preceding aspects, wherein the thicker fibers are present in the second phase in an amount of 10 to 20 weight percent, based on a fiber weight of the second phase.

Aspect 12. The filter medium of any one or more of the preceding aspects, wherein the thinner fibers are present in the second phase in an amount of 80 to 90 weight percent, based on a fiber weight of the second phase.

Aspect 13. The filter medium of any one or more of the preceding aspects, wherein the thicker fibers comprise polyethylene terephthalate fibers.

Aspect 14. The filter medium of any one or more of the preceding aspects, wherein the thinner fibers comprise polyethylene terephthalate fibers.

Aspect 15. The filter medium of any one or more of the preceding aspects, wherein the fibrous container comprises adhesive in an amount of greater than 0 and less than 10 weight percent, based on a total weight of the adsorbent.

Aspect 16. The filter medium of any one or more of aspects 1 to 14, wherein the fibrous container comprises less than 1 weight percent or 0 weight percent adhesive, based on a total weight of the adsorbent.

Aspect 17. The filter medium of any one or more of the preceding aspects, wherein the adsorbent comprises activated carbon particles, silica, zeolite, molecular sieve, clay, alumina, sodium bicarbonate, ion exchange resin, catalyst, or a combination thereof.

Aspect 18. The filter medium of aspect 17, wherein the adsorbent comprises activated carbon particles, impregnated activated carbon particles, an ion exchange resin, or a combination thereof.

Aspect 19. The filter medium of any one or more of the preceding aspects, further comprising a cover layer.

Aspect 20. The filter medium of aspect 19, wherein the cover layer comprises spunbond fibers.

Aspect 21. The filter medium of aspect 19 or 20, further comprising adhesive, wherein the adhesive is present only at an interface between the fibrous container and the cover layer.

Aspect 22. The filter medium of any one or more of the preceding aspects, having a thickness of less than or equal to 4.0 millimeters.

Aspect 23. The filter medium of any one or more of the preceding aspects, having a thickness of less than 2.5 millimeters.

Aspect 24. The filter medium of any one or more of the preceding aspects, wherein the filter medium is pleated.

Aspect 25. A gas adsorption filter, comprising the filter medium of any one or more of the preceding aspects.

Aspect 26. A cabin air filter for a vehicle, comprising the filter medium of any one or more of the preceding aspects.

Aspect 27. An air intake filter for a vehicle, comprising the filter medium of any one or more of the preceding aspects.

Aspect 28. A heating, ventilation, and air conditioning filter, comprising the filter medium of any one or more of the preceding aspects.

Aspect 29. The filter medium of any one or more of the preceding aspects, formed by a process comprising: forming the fibrous container; providing the adsorbent onto the fibrous container; and laminating the fibrous container to form the filter medium.

Aspect 30. The filter medium of aspect 29, wherein the process further comprises providing adhesive onto the fibrous container after adding the adsorbent onto the fibrous container.

Aspect 31. The filter medium of aspect 30, wherein the adhesive comprises a powder.

Aspect 32. The filter medium of aspect 30 or 31, wherein the adhesive comprises a web.

Aspect 33. The filter medium of any one or more of aspects 30 to 32, wherein the adhesive is not present in the second phase.

Aspect 34. The filter medium of any one or more of aspects 30 to 32, wherein less than 1 weight percent of adhesive is present in the second phase, based on a total weight of the second phase.

Aspect 35. The filter medium of any one or more of aspects 30 to 34, wherein forming the fibrous container comprises intermingling the thicker fibers and the thinner fibers in the open phase and the second phase.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

It will be understood that when an element is referred to as being “on” another element, it can be directly on the other element or intervening elements may be present therebetween. In contrast, when an element is referred to as being “directly on” another element, there are no intervening elements present.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined In any suitable manner in the various embodiments. A “combination thereof” is open and includes any combination comprising at least one of the listed components or properties optionally together with a like or equivalent component or property not listed.

Relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

Although the filter media and methods of the present disclosure have been described with reference to exemplary embodiments thereof, the present disclosure is not limited to such exemplary embodiments and/or implementations. Rather, the filter media and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A filter medium comprising:
a fibrous container comprising
an open phase, and
a second phase on the open phase; and
an adsorbent within the fibrous container,
wherein each of the open phase and the second phase comprise thicker fibers and thinner fibers, and
wherein an average diameter of fibers in the open phase is greater than an average diameter of fibers in the second phase.

2. The filter medium of claim 1, wherein an average pore size of the open phase is greater than an average pore size of the second phase.

3. The filter medium of claim 1, wherein a proportion of the thicker fibers in the open phase is less than or equal to a proportion of the thinner fibers in the open phase.

4. The filter medium of claim 1, wherein a proportion of the thicker fibers in the second phase is less than a proportion of the thinner fibers in the second phase.

5. The filter medium of claim 1, wherein a proportion of the thicker fibers in the open phase is greater than a proportion of the thicker fibers in the second phase.

6. The filter medium of claim 1, wherein a proportion of the thinner fibers in the open phase is less than a proportion of the thinner fibers in the second phase.

7. The filter medium of claim 1, wherein the thicker fibers are present in the open phase in an amount of 30 to 50 weight percent, based on a total fiber weight of the open phase.

8. The filter medium of claim 1, wherein the thicker fibers comprise 15 to 20 denier fibers.

9. The filter medium of claim 1, wherein the thinner fibers are present in the open phase in an amount of 50 to 70 weight percent, based on a fiber weight of the open phase.

10. The filter medium of claim 1, wherein the thinner fibers comprise 5 to less than 10 denier fibers or 7 to less than 10 denier fibers.

11. The filter medium of claim 1, wherein the thicker fibers are present in the second phase in an amount of 10 to 20 weight percent, based on a fiber weight of the second phase.

12. The filter medium of claim 1, wherein the thinner fibers are present in the second phase in an amount of 80 to 90 weight percent, based on a fiber weight of the second phase.

13. The filter medium of claim 1, wherein the thicker fibers comprise polyethylene terephthalate fibers.

14. The filter medium of claim 1, wherein the thinner fibers comprise polyethylene terephthalate fibers.

15. The filter medium of claim 1, wherein the fibrous container comprises adhesive in an amount of greater than 0 and less than 10 weight percent, based on a total weight of the adsorbent.

16. The filter medium of claim 1, wherein the fibrous container comprises less than 1 weight percent or 0 weight percent adhesive, based on a total weight of the adsorbent.

17. The filter medium of claim 1, wherein the adsorbent comprises activated carbon particles, silica, zeolite, molecular sieve, clay, alumina, sodium bicarbonate, ion exchange resin, catalyst, or a combination thereof.

18. (canceled)

19. The filter medium of claim 1, further comprising a cover layer.

20. The filter medium of claim 19, wherein the cover layer comprises spunbond fibers.

21. The filter medium of claim 19, further comprising adhesive, wherein the adhesive is present only at an interface between the fibrous container and the cover layer.

22. The filter medium of claim 1, having a thickness of less than or equal to 4.0 millimeters.

23. The filter medium of claim 1, having a thickness of less than 2.5 millimeters.

24. The filter medium of claim 1, wherein the filter medium is pleated.

25. A gas adsorption filter, comprising the filter medium of claim 1 s.

26. A cabin air filter for a vehicle, comprising the filter medium of claim 1.

27. An air intake filter for a vehicle, comprising the filter medium of claim 1.

28. A heating, ventilation, and air conditioning filter, comprising the filter medium of claim 1.

29. The filter medium of claim 1, formed by a process comprising:
forming the fibrous container;
providing the adsorbent onto the fibrous container; and
laminating the fibrous container to form the filter medium.

30. The filter medium of claim 29, wherein the process further comprises providing adhesive onto the fibrous container after adding the adsorbent onto the fibrous container.

31. The filter medium of claim 30, wherein the adhesive comprises a powder.

32. The filter medium of claim 30, wherein the adhesive comprises a web.

33. The filter medium of claim 30, wherein the adhesive is not present in the second phase.

34. The filter medium of claim 30, wherein less than 1 weight percent of adhesive is present in the second phase, based on a total weight of the second phase.

35. The filter medium of claim 30, wherein forming the fibrous container comprises intermingling the thicker fibers and the thinner fibers in the open phase and the second phase.
